(19) United States
(12) Patent Application Publication
(10) Pub. No.: US 2014/0124149 A1
(43) Pub. Date: May 8, 2014

(54) Venetian Blind and Control Device for the Same

(71) Applicant: GUANGZHOU GARDEN RUBBER & PLASTIC CO., LTD., Guangdong (CN)

(72) Inventors: Sung Chou Ho, Guangdong (CN); Dick Chen, Guangdong (CN)

(73) Assignee: Guangzhou Garden Rubber & Plastic Co., Ltd., Guangdong (CN)

(21) Appl. No.: 13/852,772

(22) Filed: Mar. 28, 2013

(30) Foreign Application Priority Data
Nov. 6, 2012 (CN) 201220581733.5

(51) Int. Cl. E06B 9/322

(52) U.S. Cl. CPC E06B 9/322
USPC 160/170

(57) ABSTRACT

A control device for a venetian blind, including a controller for controlling the venetian blind to draw and withdraw and a rotating handle for driving the controller to operate. The controller includes a first rotating member for driving a transmission shaft of the venetian blind to rotate and a second rotating member. The axis of rotation of the second rotating member and that of the first rotating member are orthogonal. The second rotating member is provided with a connection shaft connected with the rotating handle. The first rotating member is rotated coaxially with the transmission shaft to realize the drawing and withdrawing of the venetian blind. A venetian blind having the above control device for the venetian blind is further disclosed.

### CROSS-REFERENCE TO RELATED APPLICATIONS

This application claims the benefit of priority to Chinese patent application No. 201220581733.5 titled “VENETIAN BLIND AND CONTROL DEVICE FOR THE SAME”, filed with the Chinese State Intellectual Property Office on Nov. 6, 2012. The entire disclosure of which is incorporated herein by reference.

### FIELD OF THE INVENTION

The present application relates to the technical field of household items, and more particularly to a venetian blind and a control device for the same.

### BACKGROUND OF THE INVENTION

Venetian blind is a widely used one in the world of curtains, which is generally used in the office and is popular for its simplicity. The venetian blind may be divided into a horizontal type venetian blind and a vertical type venetian blind according to the manner that it is mounted, or be divided into a manually operated venetian blind and an electrically operated venetian blind according to the control manner thereof

In the horizontal type venetian blind, in a case that the venetian blind is manually controlled to draw or withdraw, the venetian blind is typically controlled to move by a blind cord or a blind string provided at an end of the venetian blind. Since the end of the cord or the string located at the bottom of the venetian blind for controlling is usually suspended, and the suspended end is usually located at the same horizontal plane as the bottom of the venetian blind, it is easy for a person or an animal to reach the blind cord or the blind string of the venetian blind. If the person or the animal contacts the blind cord or the blind string, they may be caught in the blind cord or the blind string and unable to escape, and even may suffer life risk if they are unable to escape.

Therefore, there is an urgent demand for the person skilled in the art to improve the safety in the operation of the blind cord or the blind string of the venetian blind.

### SUMMARY OF THE INVENTION

In view of this, it is provided according to the present application a control device for a venetian blind to improve the safety in the controlling of the blind cord/string of the venetian blind. It is further provided according to the present application a venetian blind having the above control device for the venetian blind.

In order to achieve the above object, it is provided according to the present application technical solutions as follows.

A control device for a venetian blind including a controller for controlling the venetian blind to draw and withdraw and a rotating handle for driving the controller to operate. The controller includes a first rotating member for driving a transmission shaft of the venetian blind to rotate and a second rotating member for driving the first rotating member to rotate. An axis of rotation of the second rotating member and an axis of rotation of the first rotating member are orthogonal, and the second rotating member is provided with a connection shaft connected with the rotating handle.

Preferably, in the above control device for the venetian blind, the first rotating member and the second rotating member are gear transmission mechanisms whose axes of rotation are orthogonal.

Preferably, in the above control device for the venetian blind, the gear transmission mechanisms are straight bevel gear transmission mechanisms.

Preferably, in the above control device for the venetian blind, the connection shaft is a rotating connection handle arranged coaxially with the second rotating member, and the rotating connection handle and the rotating handle are connected with each other through a connecting buckle.

Preferably, in the above control device for the venetian blind, a string winder of the venetian blind includes a threaded string winder sleeved on the transmission shaft and a string winder mounting seat for holding the threaded string winder. A position-limiting nut coupled to threads of the threaded string winder is sleeved on the threaded string winder, a position-limiting pole extended in a radial direction of the position-limiting nut is provided on an outer surface of the position-limiting nut, and a position-limiting block extended in an axial direction of the threaded string winder is provided on the string winder mounting seat for coupling with the position-limiting pole.

Preferably, in the above control device for the venetian blind, the position-limiting block is provided with a position-limiting groove extended in the axial direction of the threaded string winder, and the position-limiting pole is inserted in the position-limiting groove.

Preferably, in the above control device for the venetian blind, the string winder of the venetian blind includes two threaded string winders arranged on the transmission shaft.

Preferably, in the above control device for the venetian blind, two sub-ladder tapes of a ladder tape of a roller blind of the venetian blind are straight line-shaped ladder tapes.

Preferably, in the above control device for the venetian blind, at least one of two sub-ladder tapes of a ladder tape of a roller blind of the venetian blind is a meshed ring ladder tape.

A venetian blind including a roller blind and a control device for the venetian blind for controlling withdrawing and drawing of the roller blind, the control device for the venetian blind is the one according to any one of the above technical solutions.

The control device for the venetian blind according to the present application includes a controller for controlling the venetian blind to draw and withdraw and a rotating handle for driving the controller to operate. The controller is controlled to operate by the rotating handle, while the controller contols the venetian blind to draw and withdraw. By changing the control mode of the venetian blind from a blind string/cord-pulling control mode into a rotating handle control mode, a person or an animal is protected from being stuck by the blind string/cord and is protected from being hurt. The controller includes a first rotating member for driving a transmission shaft of the venetian blind to rotate and a second rotating member for driving the first rotating member to rotate. The axis of rotation of the second rotating member and the axis of rotation of the first rotating member are orthogonal. And the second rotating member is provided with a connection shaft connected with the rotating handle. By providing the first rotating member and the second rotating member whose axes of rotation are orthogonal, and the first rotating member is rotated coaxially with the transmission shaft to realize the drawing and withdrawing of the venetian blind by the transmission shaft, while the rotating handle drives the second rotating member to provide the first rotating member with the rotating power, since the first rotating member and the second rotating member are orthogonal, the control of the transmission shaft of the venetian blind in different spatial planes is realized, and thus the replacement of original blind cord/string by the rotating handle is realized, thereby the safety of the venetian blind where being used, such as being drawn or withdrawn, is improved.

### BRIEF DESCRIPTION OF THE DRAWINGS

In order to clearly illustrate embodiments of the present application or technical solutions in the prior art, drawings required for the description of the embodiments or the prior art will be briefly introduced below. Drawings described below are simply some embodiments of the present application, and those skilled in the art may also obtain other drawings, based on the followed drawings, without any creative work.

FIG. 1 is an assembly diagram of a control device for a venetian blind according to the present application;

FIG. 2 is an exploded view of FIG. 1;

FIG. 3 is an exploded view of a controller in FIG. 1;

FIG. 4 is a structural schematic view of a power-assisting handle in FIG. 1;

FIG. 5 is a structural schematic view of a straight line-shaped ladder tape of a venetian blind according to the present application;

FIG. 6 is a structural schematic view of the ladder tapes in FIG. 5 with one ladder tape being a meshed ring ladder tape;

FIG. 7 is a structural schematic view of the ladder tapes in FIG. 5 with both ladder tapes being meshed ring ladder tapes;

FIG. 8 is a partial enlarged view of the meshed ring ladder tape according to the present application;

FIG. 9 is a structural schematic view of the venetian blind according to the present application with the venetian blind being drawn to shade light;

FIG. 10 is a structural schematic view of the venetian blind according to the present application with the venetian blind being drawn to allow light to pass through; and

FIG. 11 is a structural schematic view of the venetian blind according to the present application with the venetian blind being half-drawn to allow light to pass through.

### DETAILED DESCRIPTION

It is provided according to the present application a control device for a venetian blind which improves safety in controlling the blind cord or the blind string. It is also provided according to the present application a venetian blind having the above control device for the venetian blind.

Technical solutions in the embodiments of the present application will be clearly and fully described below in conjunction with accompanying drawings in the embodiments of the present application. The described embodiments are only a part, but not all, of the embodiments of the present application. All other embodiments obtained by those ordinary skilled in the art based on the embodiments of the present application without making any creative efforts fall within the protection scope of the present application.

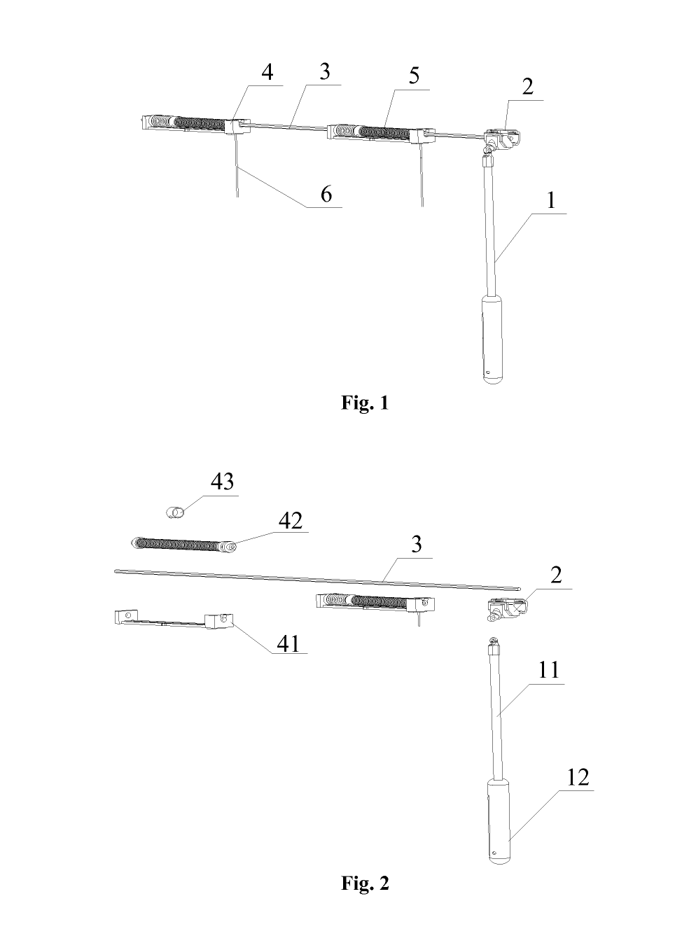

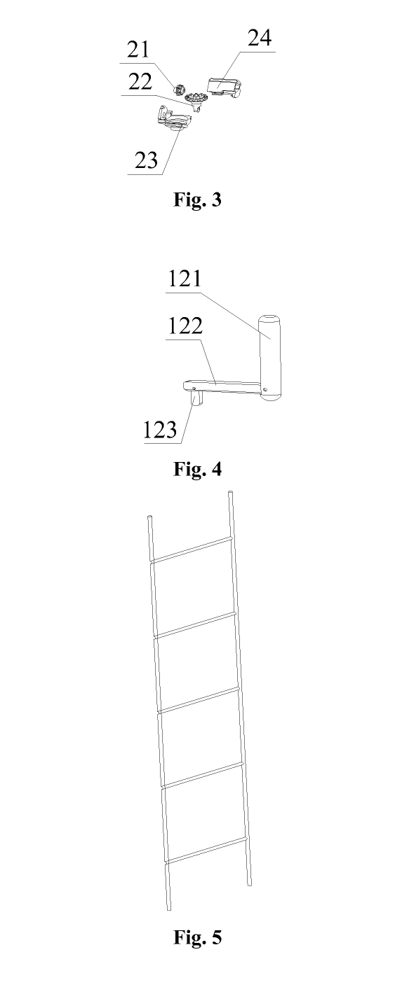

As shown in FIGS. 1 to 4, FIG. 1 is an assembly diagram of a control device for a venetian blind according to the present application, FIG. 2 is an exploded view of FIG. 1, FIG. 3 is an exploded view of a controller in FIG. 1, and FIG. 4 is a structural schematic view of a power-assisting handle in FIG. 1.

The control device for the venetian blind according to the present application includes a controller 2 for controlling the venetian blind to withdraw and draw and a rotating handle 1 for driving the controller 2 to operate. The controller 2 is controlled to operate by the rotating handle 1, and the controller 2 controls the venetian blind to withdraw and draw. By changing the control mode of the venetian blind from a blind string/cord-pulling control mode into a rotating handle control mode, a person or an animal is protected from being stuck by the blind string/cord and is protected from being hurt.

The controller 2 includes a first rotating member 21 for driving a transmission shaft 3 of the venetian blind to rotate and a second rotating member 22 for driving the first rotating member 21 to rotate. The axis of rotation of the second rotating member 22 is orthogonal to the axis of the rotation of the first rotating member 21. The second rotating member 22 is provided with a connection shaft for connecting the second rotating member with the rotating handle 1. By providing the first rotating member 21 and the second rotating member 22 whose axes of rotation are orthogonal, and the first rotating member 21 is rotated coaxially with the transmission shaft 3 to realize the drawing and withdrawing of the venetian blind by the transmission shaft 3, while the rotating handle 1 drives the second rotating member 22 to provide the first rotating member 21 with the rotating power, since the first rotating member 21 and the second rotating member 22 are orthogonal, the control of the transmission shaft of the venetian blind in different spatial planes is realized, and thus the replacement of original blind cord/string by the rotating handle 1 is realized, thereby the safety of the venetian blind where being used, such as being drawn or withdrawn, is improved.

In the present application, by changing the control mode of the drawing and withdrawing of the venetian blind from a control mode in which a string/cord is pulled into a control mode in which the controller 2 is controlled to rotate by the rotating handle 1 to draw or withdraw the venetian blind, and by providing the controller coupled to the rotating handle 1, the safety of the venetian blind is improved while the venetian blind is operated normally.

In an embodiment of the present application, the first rotating member 21 and the second rotating member 22 are configured as gear transmission mechanisms whose axes of rotation are orthogonal. The gear transmission mechanisms are simple in structure and can achieve a rapid raising and lowering of the venetian blind if the transmission ratio is appropriately set. Besides, since the gear transmission mechanisms are orthogonal, transmission performances in different transmission directions can be achieved, thereby the user can control the venetian blind at a lower position. Preferably, the gear transmission mechanisms are straight bevel gear transmission mechanisms. The straight bevel gear is easy to design, manufacture and mount, and is widely used. Where being applied to the venetian blind, the straight bevel gear is applicable to the occasion of the venetian blind where transverse transmission is performed at a higher position and control is performed at a lower position. The coupling between the straight bevel gear transmission mechanisms and the transmission shaft as well as the coupling between the straight bevel gear transmission mechanisms and the rotating handle can meet the application requirement of the venetian blind, and the straight bevel gear transmission mechanisms are easy to manufacture and mount.

The gear transmission mechanism may have various patterns, for example, the gear transmission mechanism may be configured as a helical-spur gear transmission mechanism, a worm transmission mechanism or the like.

The venetian blind is provided with a gear-mounting seat for holding the gear transmission mechanisms. The gear-mounting seat includes two portions, i.e. an upper gear-mounting seat 24 and a lower gear-mounting seat 23. The lower gear-mounting seat 23 is provided with a first mounting hole for mounting the transmission shaft 3. The transmission shaft 3 is passed through the first mounting hole and then is connected to the first rotating member 21. The lower gear-mounting seat 23 is provided with a second mounting hole for mounting the second rotating member 22 and accommodating the rotating handle. Alternatively, a rotating support, for example, a rotating bearing, may be properly attached to the first rotating member 21 and the second rotating member 22 depending on positions where they are mounted, to improve transmission flexibility and convenience of the gear transmission mechanisms.

In particular, the connection shaft is a rotating connection handle arranged coaxially with the second rotating member 22, and the rotating connection handle is connected to the rotating handle via a connecting buckle. In a case that the second rotating member and the first rotating member are straight bevel gear structures, the rotation center of the first straight bevel gear is the center hole for mounting the transmission shaft. Since the second straight bevel gear is connected to the rotating handle, serving as a power input, the rotating connection handle may be integrated with the second straight bevel gear such that a rotating center shaft of the second straight bevel gear serves as a connection end for connecting the second straight bevel gear to the rotating handle. Alternatively, the rotating connection handle and the second straight bevel gear may be provided separately, for example, the rotating connection handle may be configured as a mechanical structure to be fixedly connected to the second straight bevel gear. The specific connection mode of the rotating connection handle and the second straight bevel gear is not limited herein.

In an embodiment of the present application, a string winder 4 of the venetian blind includes a threaded string winder 42 sleeved on the transmission shaft 3 and a string winder mounting seat 41 for holding the threaded string winder 42. A position-limiting nut 43 coupled with the threads of the threaded string winder 42 is sleeved on the threaded string winder 42, and a position-limiting pole extended in the radial direction of the position-limiting nut 43 is provided on the outer surface of the position-limiting nut 43. A position-limiting block arranged in the axial direction of the threaded string winder 42 is provided on the string winder mounting seat 41 for coupling with the position-limiting pole. In the venetian blind, the ladder tape 6 of the venetian blind is furled and unfurled by the string winder such that the venetian blind is raised and lowered. The raising and lowering of the venetian blind is controlled by the threaded string winder 42, the threaded string winder 42 is sleeved on the transmission shaft 3 such that the threaded string winder 42 is driven to rotate by the transmission shaft 3. The ladder tape 6 of the venetian blind is mounted on the threaded string winder 42 such that the venetian blind is driven to raise or lower where the threaded string winder 42 is driven to rotate forwardly or reversely by the transmission shaft 3. The threaded string winder 42 is coupled with the transmission shaft 3, therefore the venetian blind can be accurately positioned, and since the threaded string winder 42 is driven to rotate by the rotating handle 1, the venetian blind is convenient to be operated.

Alternatively, the string winder may be configured as a cylindrical string winder which is sleeved on the transmission shaft and is rotated synchronously with the transmission shaft to roll up or release the ladder tape during the rotating thereof, thereby the venetian blind is withdrawn or drawn.

Where the venetian blind is controlled to withdraw and draw by the controller 2 which is directly driven by the rotating handle 1, in order to facilitate the controlling, the rotating handle 1 includes a rotating rod body 11 and a power-assisting handle 12 provided at an end of the rotating rod body 11. The power-assisting handle 12 includes: a rotating rod joint 121 which is provided, in the axial direction thereof, with a groove; and a power-assisting rod 122 hinged with the rotating rod joint 121 and in communication with the groove in the rotating rod joint 121. An end of the power-assisting rod 122 is provided with a pulling head 123 such that the power-assisting rod 122 can be pulled out of the groove easily.

During the upward withdrawing of the venetian blind, where it requires that the venetian blind be partly withdrawn or be withdrawn to the top, a positioning performance is required to avoid an automatic drawing of the venetian blind. Therefore, the position-limiting nut 43 coupled to the threaded string winder 42 is sleeved on the threaded string winder 42, which two are coupled via an internal thread and an external thread. Where the threaded string winder 42 is driven to rotate by the transmission shaft 3, the position-limiting nut 43 is moved away from or close to the terminal of the ladder tape simultaneously, thereby protecting the ladder tape from being stuck between the threaded string winder 42 and the position-limiting nut 43.

Particularly, the outer surface, i.e., the outer ring, of the position-limiting nut 43 is provided with a position-limiting pole extending in the radial direction of the position-limiting nut 34. Meanwhile, a position-limiting block arranged in the axial direction of the threaded string winder 42 is provided on the string winder mounting seat 41 for coupling with the position-limiting pole. During the rotation of the position-limiting nut 43, the position-limiting pole is abutted against the position-limiting block, and therefore the position-limiting nut 43 is stopped from rotating. During the rotation of the threaded string winder 42, the position-limiting nut 43 slides with respect to the threaded string winder 42 since the position-limiting nut 43 is stopped from rotating. Where the transmission shaft 3 is stopped, the threaded string winder 42 is rotated under the gravity of the venetian blind, and the rotation of the threaded string winder 42 is stopped by the position-limiting nut 43 such that the venetian blind is fixed at a predetermined position.

In an embodiment of the present application, the position-limiting block is provided with a position-limiting groove extended in the axial direction of the threaded string winder 42, and the position-limiting pole of the position-limiting nut 43 is inserted in the position-limiting groove. In a case that the position-limiting nut 43 is coupled to the position-limiting block merely via the position-limiting pole on its outer surface, the threaded string winder 42 may be rotated reversely under the gravity action of the venetian blind after it is rotated to a predetermined position, thereby the venetian blind cannot be withdrawn to a predetermined position. By providing the position-limiting groove, the position-limiting nut 43 can only slide in the axial direction of the threaded string winder 42 and can not be rotated. Thereby the venetian blind can be withdrawn or drawn in place. The position-limiting nut 43 can not be rotated and it does not require the position-limiting block to limit the position-limiting nut 43.

In an embodiment of the present application, the string winder 4 of the venetian blind includes two threaded string winders 42 provided on the transmission shaft 3, which two threaded string winders 42 are arranged such that the venetian blind suffers even forces and can be pulled smoothly during the pulling of the venetian blind.

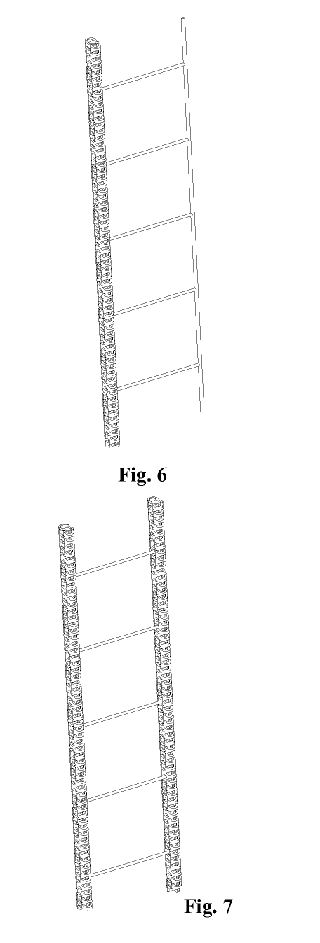

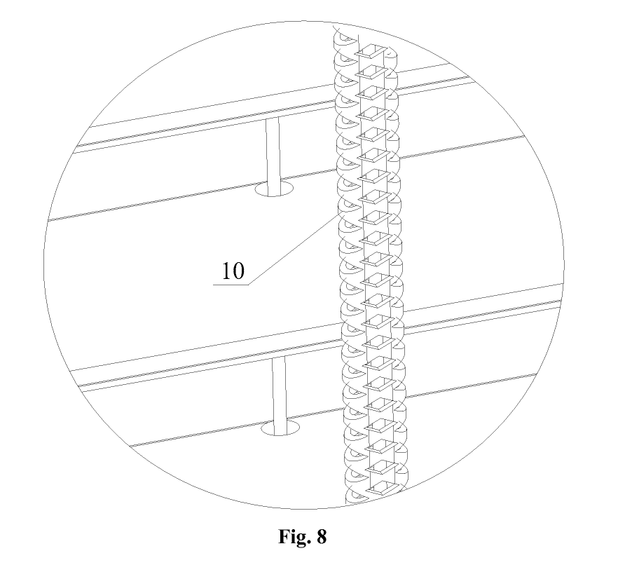

As shown in FIGS. 5 to 8, FIG. 5 is a structural schematic view of a straight line-shaped ladder tape of the venetian blind according to the present application, FIG. 6 is a structural schematic view of the ladder tapes in FIG. 5 with one ladder tape being a meshed ring ladder tape, FIG. 7 is a structural schematic view of the ladder tapes in FIG. 5 with both ladder tapes being meshed ring ladder tapes, And FIG. 8 is a partial enlarged view of the meshed ring ladder tape according to the present application.

In an embodiment of the present application, two sub-ladder tapes of the ladder tape of the roller blind of the venetian blind are straight line-shaped ladder tapes. Where the venetian blind is completely spread, the straight line-shaped ladder tapes are hidden in the blades of the venetian blind, therefore the aesthetics is improved. The straight line-shaped ladder tapes are usually cords or strings which directly pull the venetian blind. In order to further improve the aesthetics of the venetian blind where the venetian blind is in use, at least one of the two sub-ladder tapes of the ladder tape of the roller blind of the venetian blind is configured as a meshed ring ladder tape. Where there is only one meshed ring ladder tape, the meshed ring ladder tape is provided on the outer surface of the venetian blind. Alternatively, it is possible that two ladder tapes of the venetian blind are configured as meshed ring ladder tapes.

The meshed ring ladder tape 10 has a cylindrical structure, the outer wall of which is provided with two sets of hollowed out telescopic intervals, and the two sets of telescopic intervals are provided oppositely. The string or cord for pulling the venetian blind is passed through the interior of the meshed ring ladder tape 10 to realize the stacking and spreading of the blades of the venetian blind together with the meshed ring ladder tape 10. The meshed ring ladder tape 10 has good contraction and extension performances because of the design of the hollowed out holes in the outer wall thereof. Where the meshed ring ladder tape 10 is extended, the telescopic intervals provided in the outer wall thereof are opened, and thus the meshed ring ladder tape 10 is elongated; and where being contracted, the meshed ring ladder tape 10 is compressed, and the telescopic intervals on its outer wall are closed, thereby the drawing and withdrawing of the venetian blind is not affected.

Since the ladder tape of the venetian blind is configured as a meshed ring ladder tape, where the venetian blind is withdrawn, the string or cord for pulling the blades of the venetian blind is rolled up by the threaded string winder, meanwhile a part of the string or cord is hidden in the meshed ring ladder tape, therefore the aesthetics of the venetian blind in use is improved.

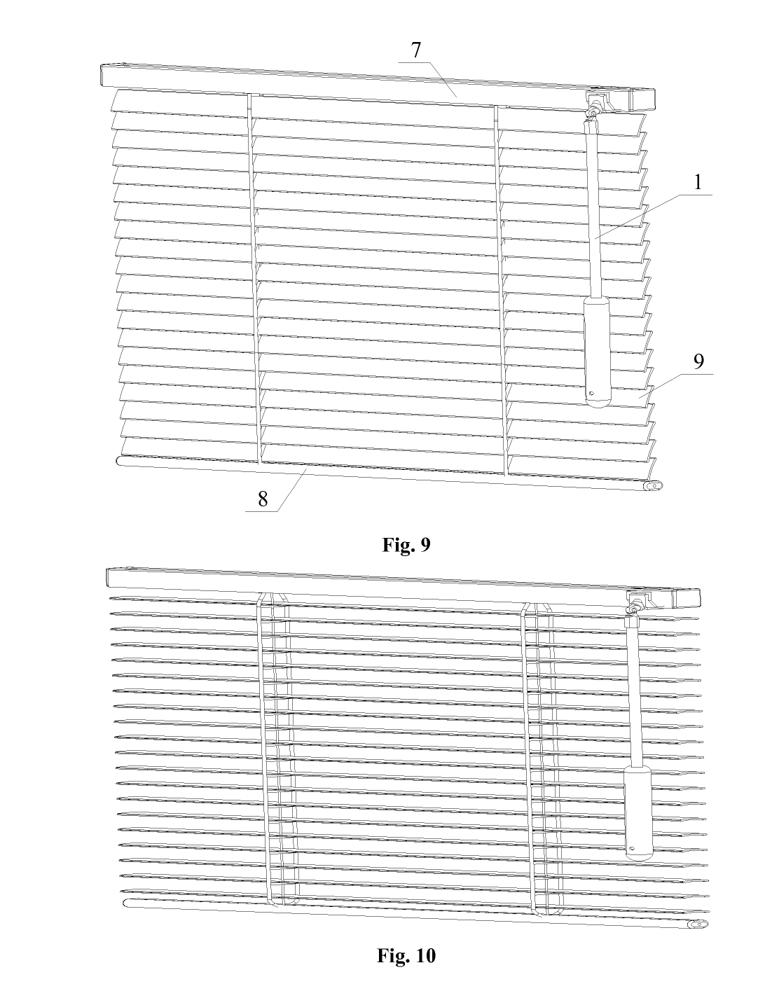

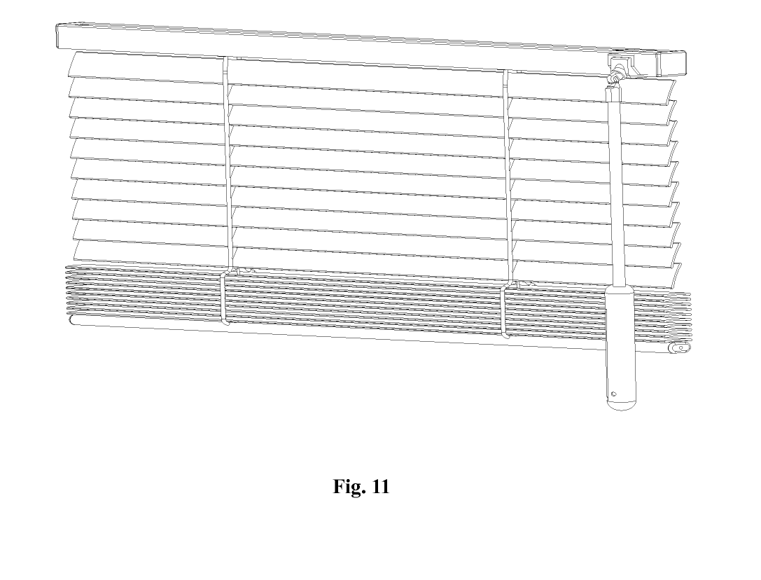

As shown in FIGS. 9 to 11, FIG. 9 is a structural schematic view of the venetian blind according to the present application with the venetian blind being drawn to shade light, FIG. 10 is a structural schematic view of the venetian blind according to the present application with the venetian blind being drawn to allow light to pass through, and FIG. 11 is a structural schematic view of the venetian blind according to the present application with the venetian blind being half-drawn to allow light to pass through.

As can be seen from the above drawings, in a case that the venetian blind is controlled by the rotating handle 1, and the venetian blind is supported by the head rail 7, the person or the animal can be protected from being stuck, and thus the safety of the venetian blind is improved. Meanwhile, a bottom rail 8 is provided at the bottom of the venetian blind for stretching the ladder tape and supporting the blades 9, thereby the venetian blind can be operated normally.

Based on the control device for the venetian blind described in the above embodiments, it is further provided according to the present application a venetian blind which includes: a roller blind; and a control device for the venetian blind as is provided in the above embodiments, for controlling the withdrawing and drawing of the venetian blind.

As can be seen from the different operation states of the venetian blind shown in FIGS. 9 to 11, in a case that the venetian blind is controlled by the rotating handle 1, and the venetian blind is supported by the head rail 7, the person or the animal can be protected from being stuck, and thus the safety of the venetian blind is improved. Meanwhile, the bottom rail 8 is provided at the bottom of the venetian blind for stretching the ladder tape and supporting the blades 9, thereby the venetian blind can be operated normally.

Since the venetian blind employs the control device for the venetian blind of the above embodiments, reference may be made to the above embodiments for the advantageous effects of the venetian blind brought by the control device for the venetian blind.

The embodiments are described herein in a progressive manner. Description of each of the embodiments is mainly focused on differences between the embodiment and the other embodiments, and references may be made among these embodiments with respect to the same or similar components.

Those skilled in the art can achieve or implement the present application based on the above description of the embodiments herein, and it is apparent that those skilled in the art may make multiple modifications to the embodiments. The general principle defined herein can be implemented in other embodiments without departing from the spirit or scope of the present application. Therefore, the present application will not be limited to the embodiments described herein, but to be in accordance with the widest scope consistent with the principle and novel features disclosed herein.

What is claimed is:

1. A control device for a venetian blind, comprising:
a controller for controlling the venetian blind to draw and withdraw; and
a rotating handle for driving the controller to operate;
wherein the controller comprises a first rotating member for driving a transmission shaft of the venetian blind to rotate and a second rotating member for driving the first rotating member to rotate;
wherein an axis of rotation of the second rotating member and an axis of rotation of the first rotating member are orthogonal;
wherein the second rotating member is provided with a connection shaft connected with the rotating handle.

2. The control device for the venetian blind according to claim 1, wherein the first rotating member and the second rotating member are gear transmission mechanisms whose axes of rotation are orthogonal.

3. The control device for the venetian blind according to claim 2, wherein the gear transmission mechanisms are straight bevel gear transmission mechanisms.

4. The control device for the venetian blind according to claim 3, wherein the connection shaft is a rotating connection handle arranged coaxially with the second rotating member, and the rotating connection handle and the rotating handle are connected with each other via a connecting buckle.

5. The control device for the venetian blind according to claim 1, wherein a string winder of the venetian blind comprises a threaded string winder sleeved on the transmission shaft and a string winder mounting seat for holding the threaded string winder, and wherein a position-limiting nut coupled to threads of the threaded string winder is sleeved on the threaded string winder, a position-limiting pole extended in a radial direction of the position-limiting nut is provided on an outer surface of the position-limiting nut, and a position-limiting block extended in an axial direction of the threaded string winder is provided on the string winder mounting seat for coupling with the position-limiting pole.

6. The control device for the venetian blind according to claim 5, wherein the position-limiting block is provided with a position-limiting groove extended in the axial direction of the threaded string winder, and the position-limiting pole is inserted in the position-limiting groove.

7. The control device for the venetian blind according to claim 5, wherein the string winder of the venetian blind comprises two threaded string winders arranged on the transmission shaft.

8. The control device for the venetian blind according to claim 1, wherein two sub-ladder tapes of a ladder tape of a roller blind of the venetian blind are straight line-shaped ladder tapes.

9. The control device for the venetian blind according to claim 1, wherein at least one of two sub-ladder tapes of a ladder tape of a roller blind of the venetian blind is a meshed ring ladder tape.

10. A venetian blind comprising a roller blind and a control device for the venetian blind for controlling withdrawing and drawing of the roller blind, wherein the control device for the venetian blind is the one according to claim 1.

11. A venetian blind comprising a roller blind and a control device for the venetian blind for controlling withdrawing and drawing of the roller blind, wherein the control device for the venetian blind is the one according to claim 2.

12. A venetian blind comprising a roller blind and a control device for the venetian blind for controlling withdrawing and drawing of the roller blind, wherein the control device for the venetian blind is the one according to claim 3.

13. A venetian blind comprising a roller blind and a control device for the venetian blind for controlling withdrawing and drawing of the roller blind, wherein the control device for the venetian blind is the one according to claim 4.

14. A venetian blind comprising a roller blind and a control device for the venetian blind for controlling withdrawing and drawing of the roller blind, wherein the control device for the venetian blind is the one according to claim 5.

15. A venetian blind comprising a roller blind and a control device for the venetian blind for controlling withdrawing and drawing of the roller blind, wherein the control device for the venetian blind is the one according to claim 6.

16. A venetian blind comprising a roller blind and a control device for the venetian blind for controlling withdrawing and drawing of the roller blind, wherein the control device for the venetian blind is the one according to claim 7.

17. A venetian blind comprising a roller blind and a control device for the venetian blind for controlling withdrawing and drawing of the roller blind, wherein the control device for the venetian blind is the one according to claim 8.

18. A venetian blind comprising a roller blind and a control device for the venetian blind for controlling withdrawing and drawing of the roller blind, wherein the control device for the venetian blind is the one according to claim 9.
